(19) United States
(12) Patent Application Publication
(10) Pub. No.: US 2001/0050603 A1
(43) Pub. Date: Dec. 13, 2001

(54) Microwave dielectric material

(76) Inventor: Leif Bergstedt, Sjomarken (SE)

Correspondence Address: Ronald L. Grudziecki, Esquire, BURNS, DOANE, SWECKER & MATHIS, L.L.P., P.O. Box 1404, Alexandria, VA, 22313-1404, US

(21) Appl. No.: 09/829,247

(22) Filed: Apr. 9, 2001

Related U.S. Application Data
(63) Continuation-in-part of application No. 09/377,272, filed on Aug. 19, 1999, now abandoned.

(30) Foreign Application Priority Data
Aug. 19, 1998 (SE) 9802769-1

(51) Int. Cl. H01P 3/08

(52) U.S. Cl. 333/238; 333/246

(57) ABSTRACT

A laminate construction for use in microwave electronics, such as for circuit boards or antennas, has expensive dielectric material having a low dissipation factor (D_{f}<0.005 at 1 GHz), such as PTFE/glass or GORE-PLY®, only in the upper 200 μm and less expensive dielectric material having a higher dissipation factor (D_{f}>0.005 at 1 GHz), such as FR-4, cyanate ester, BT/epoxy, polyimide thermount or polyimide, in the underlying 400 μm of the dielectric material, thereby reducing cost while maintaing the same performance as regards low energy loss and consistency of the dielectric constant over the temperature and frequency range of use.

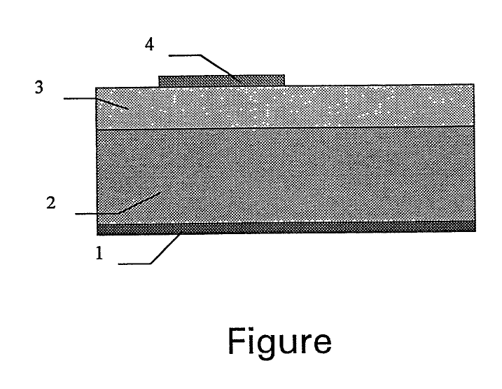

This application is a continuation-in-part of co-pending U.S. patent application Ser. No. 09/377,272, filed Aug. 19, 1999, of which the entire content is hereby incorporated by reference.

### BACKGROUND

The present invention relates to laminate constructions containing dielectric material for use in microwave electronics. They can be used for microwave applications in inter alia component carriers such as circuit boards and in microwave antennas. The invention also relates to a method of manufacturing such new dielectric laminate constructions.

In such dielectrics it is important that there not be excessive variations in the dielectric constant (Dₖ) over the temperature and frequency ranges of use. It is also important that the dissipation factor (D_{f} or tan δ) should be low, so that there will be a minimum energy loss (heat). This has been achieved previously by arranging a dielectric layer to support a microstrip conducting layer thereon. In order to achieve the just described desired effects, a dielectric material layer is applied which has the desired properties.

The dielectric materials used in these designs can have a thickness of about 600 μm, and dielectric materials having the desired or required properties can increase the cost of the board significantly. In GSM mobile radio systems, for example, an antenna having a large amount of material is used, which can be very expensive if high quality dielectric material must be used.

### SUMMARY

In accordance with the foregoing background discussion, an object of this invention is to provide a dielectric laminate that is useful for microwave electronic component carriers and dielectric microwave antennas and that is less expensive than hitherto known component carriers or antennas but that provides the same high quality properties with respect to low total dissipation factor, viz., low heat generation and low variation in dielectric constant. This is especially desirable in antennas using significant amounts of materials, such as those used in the new GSM 1.8 system. Tests on which the present invention is based have shown that for a frequency of 1 GHz only the top 200 μm of the laminate board need be of top quality with respect to its dissipation factor and the underlying portion can be of lesser quality, thus reducing the total cost of the laminate.

Another object of the present invention is to provide a method of manufacturing such a laminate for component carriers and antennas.

### BRIEF DESCRIPTION OF THE DRAWINGS

The sole FIGURE shows schematically a composite microwave board.

### DETAILED DESCRIPTION

The sole FIGURE shows an embodiment of the invention that is a composite microwave board. To a ground plane 1, there is applied a lower layer 2 of a less expensive dielectric material, which in this case is an FR-4 material. It is also possible within the scope of the invention to use other materials having a dissipation factor at 1 GHz that is greater than 0.005, such as cyanate ester, BT/epoxy, polyimide thermount, or polyimide. To this lower layer 2, there is applied an upper layer 3 of a higher quality material, such as PTFE/glass or GORE-PLY®. This upper layer 3 has a dissipation factor D_{f} at 1 GHz that is less than 0.005.

The dissipation factor D_{f} is used as a measure of the energy lost (heat) in relation to energy stored at a certain microwave frequency (in this case 1 GHz). This dissipation factor can be expressed a tan δ where δ is the angle formed by the vector components ε′ and ε″ where ε′ is a real component corresponding to the energy stored and ε″ is an imaginary component corresponding to the dissipated energy, called the loss factor. In a vector diagram (not shown), ε′ and ε″ are represented as 90° out of phase, and therefore the ratio between them can be represented as tan δ where δ is the angle formed by the two vectors.

In the method according to the invention, a lower layer 2 of less expensive dielectric material having a high dissipation factor (D_{f}>0.005) is applied to a ground plane 1. This layer may have a thickness of 400 μm of a total dielectric thickness of 600 pm. An upper layer 3 (about 200 μm) of a more expensive dielectric material (D_{f}<0.005) is then applied onto the lower layer 2. A conductor layer 4 is then applied to the upper layer 3. Electronic components may be mounted on the conductor layer 4.

In addition to the description above, the laminate construction includes a lower layer and an upper layer, in which the lower layer has a dielectric constant Dₖ that is greater than or substantially equal to the dielectric constant Dₖ of the upper layer. If the lower layer has a dielectric constant Dₖ that is lower than the dielectric constant Dₖ of the upper layer, then the signals may spread in the horizontal plane and give rise to intermodulation or cross-talk. By selecting the lower and upper layers such that Dₖ for the lower layer is always greater than or substantially equal to the Dₖ of the upper layer (or equivalently that Dₖ for the upper layer is always less than or substantially equal to the Dₖ of the lower layer) at the same time as the dissipation factor D_{f} of the lower layer is high (>0.005 at 1 GHz) and the dissipation factor D_{f} of the upper layer is low (<0.005 at 1 GHz), the beneficial performance described above is achieved at the same time as intermodulation or cross-talk is prevented.

In one particularly advantageous embodiment, the upper layer is made from sheets of a PTFE/ceramic composite marketed under the designation Rogers Ro 3003 having a Dₖ=3.0 and a D_{f}=0.0013 laid on a lower layer of dry thermosetting epoxy and fiberglass fabric (prepreg) having a Dₖ=3.8 and a D_{f}=0.02. The package is then cured under heat and pressure.

What is claimed is:

1. A laminate construction for microwave electronics applications, comprising:
at least one ground plane, a lower layer of dielectric material having a dissipation factor D_{f} at 1 GHz of greater than 0.005, applied to the at least one ground plane, an upper layer of dielectric material having a dissipation factor Df at 1 GHz of less than 0.005 applied to the lower layer, and
a conductor layer on the upper layer,
wherein the material of the lower layer has a dielectric constant Dₖ that is greater than or substantially equal to the dielectric constant Dₖ of the material of the upper layer.

2. The laminate construction of claim 1, wherein the upper layer is approximately 200 μm thick.

3. A method of manufacturing a laminate construction, comprising the following steps:
applying onto a ground plane a lower layer of dielectric material having a dissipation factor D_{f} at 1 GHz of greater than 0.005,
applying onto the lower layer an upper layer of dielectric material having a dissipation factor D_{f} at 1 GHz of less than 0.005 and having a dielectric constant Dₖ which is less than or substantially equal to the dielectric constant Dₖ of the lower layer, and
thereafter applying a conductor layer onto the upper layer.

4. The method of claim 3, wherein the upper layer is approximately 200 μm thick.
